(19) United States
(12) Patent Application Publication
(10) Pub. No.: US 2022/0211056 A1
(43) Pub. Date: Jul. 7, 2022

(54) FOOD AND BEVERAGE COLD SMOKING DEVICE

(71) Applicant: Phillip Brent PATTERSON, Charleston, SC (US)

(72) Inventor: Phillip Brent PATTERSON, Charleston, SC (US)

(21) Appl. No.: 17/569,347

(22) Filed: Jan. 5, 2022

Related U.S. Application Data
(60) Provisional application No. 63/134,011, filed on Jan. 5, 2021.

(51) Int. Cl. A23B 4/052; A23L 5/30

(52) U.S. Cl. CPC A23B 4/052; A23L 5/30

(57) ABSTRACT

A food and beverage cold smoking device includes a sealed a sealed container, an adjustable downstem pipe, an incendiary device, a flavoring agent, and an external pump. The sealed container includes an intake port and an exhaust port. The pipe passes through the intake port and provides a channel for the smoke to travel to reach the container. The incendiary device is coupled to a first end of the pipe. The flavoring agent is burned in the incendiary device and the smoke is pulled through a vacuum into the container via operation of the pump.

### CROSS REFERENCE TO RELATED APPLICATIONS

This application claims the benefit of an earlier filing date and right of priority to U.S. Provisional Application No. 63/134,011, filed 5 Jan. 2021, the contents of which is incorporated by reference herein in its entirety.

### BACKGROUND OF THE INVENTION

### 1. Field of the Invention

The present application relates to a smoking device, and more particularly to a cold smoking device for foods and beverages.

### 2. Description of Related Art

Smoke is the complex production of very complicated compounds that occur during the thermal decomposition of wood (chips or sawdust). Smoke is typically occurs in the temperature range of 390° F. and 750° F. Initially when created, smoke is a gas but quickly it separates into a vapor and a particle state. It is the vapor phase that contains the components largely responsible for the flavor and aroma that smoke imparts to foods. More than 300 different compounds have been isolated from wood smoke. The components most commonly found are phenols, organic acids, alcohols, carbonyls, hydrocarbons, and some gaseous components such as carbon dioxide, carbon monoxide, oxygen, nitrogen, and nitrous oxide. Smoke is applied to meat to aid in preservation, to provide a surface treatment to the meat, add flavor, and develop desired coloring effects in the meat.

Traditional food and beverage cold smoking devices utilize forced air systems to deliver flavored smoke into a sealed, semi-sealed or non-sealed atmosphere containing the subject of intended flavoring by the smoke, namely meat usually. These traditional systems create the flavoring smoke in the open atmosphere and deliver the smoke to the subject of the flavoring by filling a sealed, semi-sealed or non-sealed atmosphere with the flavored smoke that contains the subject of the flavoring. The smoke is blown into the atmosphere or casually allowed to fill the atmosphere around the subject to be flavored. The smoke fails to fully penetrate the subject nor does it adequately fill the atmosphere fully. Although strides have been made with flavoring via smoke, shortcomings remain.

### BRIEF SUMMARY OF THE INVENTION

It is an object of the present application to provide a device that creates a vacuum in an atmosphere surrounding an object desired to be flavored through the exposure of the object to smoke. The flavor is in the smoke and is drawn into the surrounding atmosphere of the object so as to impart and infuse flavoring to the object. The device provides a sealed atmosphere around the object and a vacuum to drawn in a flavoring smoke. The creation of a vacuum pulls the smoke into the atmosphere as it is created and at the same time exhausts existing clean air from the sealed atmosphere eventually clearing the original atmosphere of clean air and replacing with the smoke. This new process also allows liquids to be smoked from within by pulling the smoke through the liquid as it enters the sealed chamber. The device of the present application may also impart a medicinal effect into the object when passed through the smoke.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a food and beverage smoke device according to an embodiment of the present application.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the food and beverage smoking device of the present application is configured to induce a vacuum into an atmosphere surrounding an object to be smoked. The vacuum is configured to draw in the smoke as it is created. The clean air within the sealed atmosphere is pushed out and the smoke is infused into the object.

The device of the present application creates an airflow that passes through the chamber. This airflow creates a vacuum and pulls the smoke directly from the burning material into the chamber and evacuates the chamber of fresh air as the smoke from the burning material fills the chamber. This process creates a chamber more dense in smoke flavoring agent than is realized by just pushing smoke into an existing atmosphere without evacuating the atmosphere of non-smoke atmosphere simultaneously.

Furthermore, in this process, the produced smoke can be pulled directly into and through the liquid thereby imparting substantially more flavor producing particles into the liquid than possible by exposing only the surface area of the liquid to the flavoring particles. The intensity of the flavor enhancement will be increased with this technique by the process of thermophoresis. Thermophoresis is a force that moves particles from a warm to a cold surface. Therefore, when the temperature of the liquid is below the temperature of the gas (smoke) from the combustion of the organic matter, the transfer of the flavoring particles to the liquid is instantaneous. The larger the difference in temperature, the more the effect. This technique provides a much faster and more efficient infusion than was available previously. This saves time in the flavoring process and saves on the amount of combustible organic matter required to reach the desired level of flavor infusion.

This system of airflow also feeds a continuous supply of oxygen through the organic matter making ignition of the organic matter much easier, like lighting a pipe for smoking tobacco. Currently other inventions must use a torch to push the smoke into the target of infusion. This new system requires a minimal flame such as a match.

A chamber created to control directionally airflow through said chamber directing said air flow initiating at the inlet port where a combustion receptacle capable of combusting plant based combustible flavoring agents, such as wood chips, is located, then through a piping apparatus which extends into the chamber, or for more intense effect, directly into the liquid based target of smoke flavor infusion, exiting said liquid through buoyancy and ultimately said chamber through an exit port where by mechanical means such as an electric fan is used to create said airflow. This mechanically induced air flow provides a steady flow of oxygen to the combustion receptacle ensuring the combustible matter will burn efficiently reducing the time required to reach a satisfactory level of smoke delivered to the target and reducing the amount of said material required to reach a satisfactory level of smoke. Upon ignition of said material the air stream becomes intensely saturated with smoke. This intensely saturated air stream filters through the liquid infusing the liquid with flavor as it passes through. This continuous stream of air ensures the combustible material will not be starved of oxygen. A fire starved of oxygen smolders and produces smoke high in soot imparting an unfavorable bitter taste to the subject. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The cold smoking food and beverage device of the present application includes an airtight container, an air pump, an intake port on the container, and an incendiary device. This cold smoking device delivers smoke flavoring to foods and beverages by creating a vacuum in a sealed atmosphere in which the target of the flavoring is located. The original atmosphere in the sealed container is removed and replaced with the smoke from the flavoring agent, i.e. wood chips, thereby creating an atmosphere more dense in smoke than one where smoke is simply added to the existing atmosphere. This new process provides a more intense infusion of the flavoring into the object. Additional features and functions are illustrated and discussed below.

The process of cold smoke flavoring acts to impart particles contained in the smoke are attached and infused to food items which are the target of said flavoring. These particles are in the gaseous vapor created from the combustion of organic matter such as wood fragments. The particles attach to the food item by the interaction of the two in the same atmosphere. As noted previously, traditionally the smoke/gaseous vapor is created or introduced in an atmosphere containing the target of flavor infusion by positive force, in other words, pushing the smoke into the atmosphere wherein the subject is contained. Smoke is produced and the said atmosphere is filled with the smoke. When the desired target is liquid, only the surface of the target is exposed to the smoke particles that create the flavor.

Referring now to the FIGURES wherein like reference characters identify corresponding or similar elements in form and function throughout the several views. The following FIGURES describe embodiments of the present application and its associated features. With reference now to the FIGURES, embodiments of the present application are herein described. It should be noted that the articles “a”, “an”, and “the”, as used in this specification, include plural referents unless the content clearly dictates otherwise.

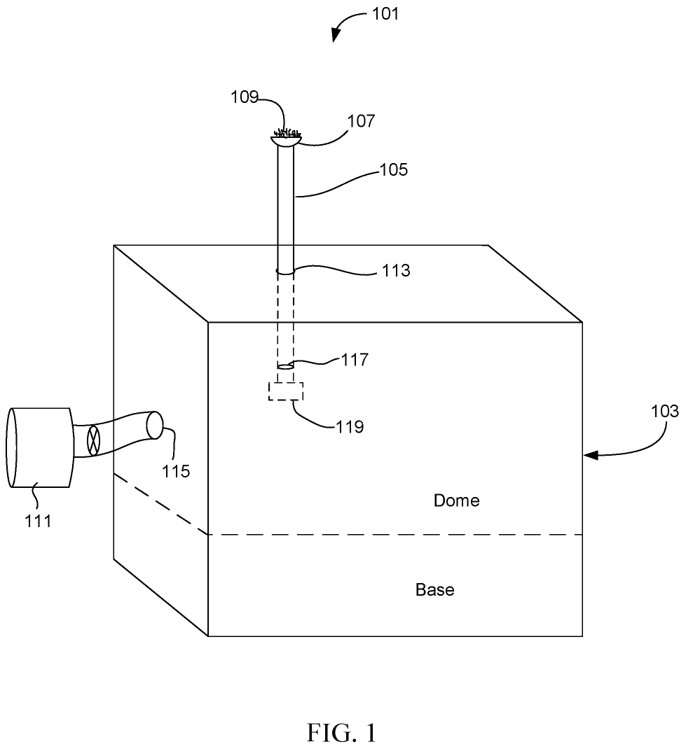

Referring now to FIG. 1 in the drawings, a food and beverage cold smoking device 101 is illustrated. Device 101 includes a sealed a sealed container 103, an adjustable downstem pipe 105, an incendiary device 107, a flavoring agent 109, and an external pump 111. The sealed container 103 includes an intake port 113 and an exhaust port 115. Pipe 105 passes through intake port 113 and provides a channel for the smoke to travel to reach container 103. Incendiary device 107 is coupled to a first end of pipe 105. Flavoring agent 109 is burned in device 107 and the smoke is pulled through a vacuum into container 103 via operation of pump 111.

Container 103 is large enough to hold the object to be smoked (i.e. food). As noted container 103 as two ports 113/115. Sealed container 103 is configured to be any desired size and shape. It is desired that container 103 be air tight in that the walls and edges do not permit the passage of smoke, vapor, or air. The internal atmosphere in container 103 is to be controlled or regulated by operation of pump 111. Container 103 may include a detachable or openable portion to permit access. This area may serve as a catch basin for spilled liquids or dripped particles and permit a cleaning access port for a user to clean the interior of container 103. If the container is separable or dividable into two or more members, namely at least a base and a dome upper, then the upper dome portion may include handles or grips as needed. Any portion of device 101 may also be at least partially transparent to permit viewing internally.

Pump 111 is externally located but it is understood that pump 111 may be at least partially located internally if needed. In some embodiments pump 111 may be directly coupled to a side of container 103 to eliminate the need for any ducting between exhaust port 115 and container 103 or pump 111. Pump 111 may operate in a plurality of different speeds which correlate directly with the level of vacuum induced within container 103. As smoke is pulled into container 103, the prior clean air is evacuated so as to make room for more smoke. The pump 111 can be adjusted to regulate the amount of smoke, or density of smoke, permitted within container 103. For example one or more valves may be located at exhaust port 115 to be operated by a user. A variable release valve or variable speed motor in pump 111 aids in adjusting the amount of air flow providing the optimal amount of aeration according to the viscosity of the liquid/object to be smoked.

Downstem pipe 105 passes through and seals against intake port 113. A grommet provides an airtight seal allowing pipe 105 to be set at the optimal depth in the liquid or container for smoke infusion and aeration. Pipe 105 is adjustable in that the length of pipe 105 may be translated into or out of container 103 a desired amount. This allows the user to regulate the location or second end of pipe 105 in container 103 and therefore the point within container 103 that the smoke will be emitted. Although not shown, it is conceivable that pipe 105 allow for telescoping to allow for length adjustment beyond just translation through intake port 113.

Pipe 105 may include a screen 117 to filter out the smoke prior to reaching the sealed container. Screen 117 may be located within container 103 or external to container 103. Ideally screen 117 is situated within pipe 105 and may be at the first end of pipe 105 adjacent incendiary device 107. Screen 117 is used to filter out the smoke prior to introduction into container 103. Screen 117 keeps the ash out of the liquid in addition to a cavity in the base of the aeration device. Primarily the need is to ensure debris or particulates are obstructed from falling into container 103.

Incendiary device 107 is located at the first end of pipe 105 external to the controlled atmosphere of container 103. It is understood that container 103 may be built to include multiple chambers wherein each chamber may be fully isolated from the others. In such embodiments, any of the externally located items as depicted in FIG. 1 may be internally located. It is of note that the smoke filled chamber atmosphere for holding the objects to be smoked are separated from those of the other items as described.

Device 107 is used to hold and burn a flavoring agent 109. Device 107 may incorporate a fully encapsulated burning chamber or an open air burning chamber. This chamber may be referred to as a bowl. Device 107 is configured to be detachable from pipe 105 to permit quick cleaning. Additionally, the bowl may be insulated to allow the user to touch the bowl/device 107 without harm. An insulated bowl allows for handling and quickly changing the material to be burned. The bowl may have a ridge inside to securely hold a replaceable screen and have a smooth bore in the bottom with an O-ring for tight seal and quick removal for clearing bowl between flavors.

Device 101 may also include a diffuser 119 coupled to pipe 105. Diffuser 119 is configured to evenly disperse the smoke from agent 109 as it reaches container 103. Diffuser 119 is coupled to a second end of pipe 105 and is located within the atmosphere of container 103.

In operation, agent 109 of choice is added to device 107. It may be ignited and begin to produce a smoke. Pump 111 may be turned on when the vacuum is desired in container 103. Adjustment of the pipe 105 may be done as well as using or not using screen 117 or diffuser 119. As the vacuum is created, the flavoring agent is ignited, thereby pulling the smoke from the flavoring agent into the atmosphere while simultaneously removing the original clean air from the sealed atmosphere. The incendiary device 107 may also have an adjustable down stem that can be immersed in liquid thereby pulling the smoke through the liquid as it enters the chamber providing intense flavor infusion to the liquid from within.

Anyone wishing to add the extra dimension of smoke infused flavors to food or beverages would place the desired item into the chamber, sealed the desired flavoring agent, create the vacuum and ignite the flavoring agent, subsequently filling the chamber with smoke thereby infusing the item with the smoke flavor.

It should be reiterated that the current description has provided context for the introduction of flavor through smoke into an object within the container. It is understood that device 101 may also be useful in other fields of science where items need to be infused with derivatives of incinerated materials. This could include medicinal applications when an object is infused with agents containing medicinal properties.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A food and beverage cold smoking device, comprising:
a sealed container having an intake port and an exhaust port;
an adjustable downstem pipe to pass through the intake port;
an incendiary device coupled to a first end of the downstem pipe;
a flavoring agent in a portion of the incendiary device; and
an external pump in communication with the exhaust port, the external pump configured to induce a vacuum and draw air through the downstem pipe and into the sealed container.

2. The device of claim 1, further comprising:
a diffuser to disperse the smoke as it reaches the sealed container.

3. The device of claim 2, wherein the diffuser is coupled to a second end of the downstem pipe within the sealed container.

4. The device of claim 1, wherein the pump has a plurality of speeds to which it may operate and therefore different levels of vacuum.

5. The device of claim 1, wherein the incendiary device is insulated.

6. The device of claim 1, wherein the incendiary device includes a seal in communication with the downstem pipe.

7. The device of claim 1, wherein the incendiary device is detachable.

8. The device of claim 1, wherein the downstem pipe includes a screen to filter out the smoke prior to reaching the sealed container.

9. The device of claim 1, wherein the smoke is filtered through a screen prior to entering the sealed container.

10. The device of claim 9, wherein the screen is external to the sealed container adjacent the incendiary device.

11. The device of claim 1, wherein the external pump is coupled directly to the sealed container.

12. The device of claim 1, wherein at least one of the sealed container, incendiary device, and the downstem pipe is partially transparent to permit visual inspection inside.

13. The device of claim 1, wherein the sealed container is dividable into two or more members.
